(19) United States
(12) Patent Application Publication
(10) Pub. No.: US 2025/0323581 A1
(43) Pub. Date: Oct. 16, 2025

(54) VOLTAGE CONVERTER OUTPUT CURRENT REGULATION SYSTEM

(71) Applicant: TEXAS INSTRUMENTS INCORPORATED, DALLAS, TX (US)

(72) Inventor: ISAAC COHEN, DIX HILLS, NY (US)

(21) Appl. No.: 18/636,789

(22) Filed: Apr. 16, 2024

(51) Int. Cl. H02M 3/335

(52) U.S. Cl. CPC H02M 3/33576

(57) ABSTRACT

In a described example, a circuit includes a switching system and a reference controller. The reference controller includes an output voltage sampler and a variable reference generator. The switching system is configured to activate a primary switch to provide an input current through a flyback inductor in response to an instantaneous amplitude of an output current falling below a predetermined threshold. Additionally, the switching system is configured to deactivate the primary switch in response to the input current increasing greater than a variable peak current amplitude. The output voltage sampler is configured to sample an output voltage of the flyback inductor in response to the deactivation of the primary switch. The variable reference generator is configured to generate the variable peak current amplitude based on the output voltage of the flyback inductor.

### TECHNICAL FIELD

This description relates to systems and methods for regulating output current of a voltage converter.

### BACKGROUND

Power converters are becoming increasingly commonplace in the electrical industry. Product manufacturers and suppliers of electrical equipment are demanding ever-increasing functionality (i.e., lower input and output voltages, higher currents, faster transient response) from their power supply systems. The flyback converter is an isolated power converter. The two prevailing control schemes are voltage mode control and current mode control. In the majority of cases, current mode control needs to be dominant for stability during operation. Both modes require a signal related to the output voltage for feedback to regulate the output current.

### SUMMARY

In a described example, a circuit includes a switching system and a reference controller. The reference controller includes an output voltage sampler and a variable reference generator. The switching system is configured to provide an input current through a flyback inductor in response to an instantaneous amplitude of an output current falling below a predetermined threshold. Additionally, the switching system is configured to detect the input current increasing greater than a variable peak current amplitude. The output voltage sampler is configured to sample an output voltage of the flyback inductor in response to detecting the input current increasing greater than the variable peak current amplitude. The variable reference generator is configured to generate the variable peak current amplitude based on the output voltage of the flyback inductor.

In a described example, a voltage converter system includes a first stage and a second stage. The first stage includes a switching system and a reference controller. The switching system is configured to activate a primary switch to provide an input current through a flyback inductor in response to an instantaneous amplitude of an output current falling below a predetermined threshold. Additionally, the switching system is configured to deactivate the primary switch in response to the input current increasing greater than a variable peak current amplitude. The reference controller is configured to sample an output voltage at the flyback inductor in response to the deactivation of the primary switch. Additionally, the reference controller is configured to generate the variable peak current amplitude based on the output voltage of the flyback inductor. The second stage is configured to provide the output current as a constant average output current based on the variable peak current amplitude.

In a described example, a circuit includes a switching system and a reference controller. The reference controller includes an output voltage sampler and a variable reference generator. The switching system has a first input, a second input, a third input, and an output. The first input of the switching system is coupled to a flyback inductor. The second input of the switching system is coupled to an output of an output current detector. The output voltage sampler has a first input, a second input, and an output. The first input of the output voltage sampler is coupled to the flyback inductor. The second input of the output voltage sampler is coupled to the output of the switching system. The variable reference generator has an input and an output. The input of the variable reference generator is coupled to the output of the output voltage sampler. The output of the variable reference generator is coupled to the third input of the switching system.

### BRIEF DESCRIPTION OF THE DRAWINGS

FIG. 1 is a block diagram of an example of a flyback converter system.

FIGS. 2A-2B is a timing diagram of waveforms associated with a flyback converter system, in an example.

FIG. 3 is a schematic diagram of an example of a current regulation circuit for a flyback converter system.

### DETAILED DESCRIPTION

This description relates to regulating output current of a voltage converter. According to one example, a flyback converter and a buck-boost converter are equivalents when they are isolated. The flyback converter system described herein is arranged similarly to a buck-boost converter, due to the use of a flyback inductor. Therefore, as described herein, the term “flyback converter” is used to describe either a buck-boost converter or a traditional transformer-based flyback converter. For example, the regulation of the average output current of the flyback converter can be achieved by generating a reference for a peak amplitude Iₚₖ for input current of a flyback inductor, causing the flyback converter system to have a regulated current output that is a constant average output current. For example, the peak input current Iₚₖ can be generated to have a variable amplitude based on variations to the load or to input conditions. As a result, the flyback converter system can maintain a constant average amplitude of the output current in response to changes to the input or output conditions. Although described with respect to a flyback inductor, it will be appreciated that the concepts and description described herein can be implemented via a transformer rather than a flyback inductor by one skilled in the art.

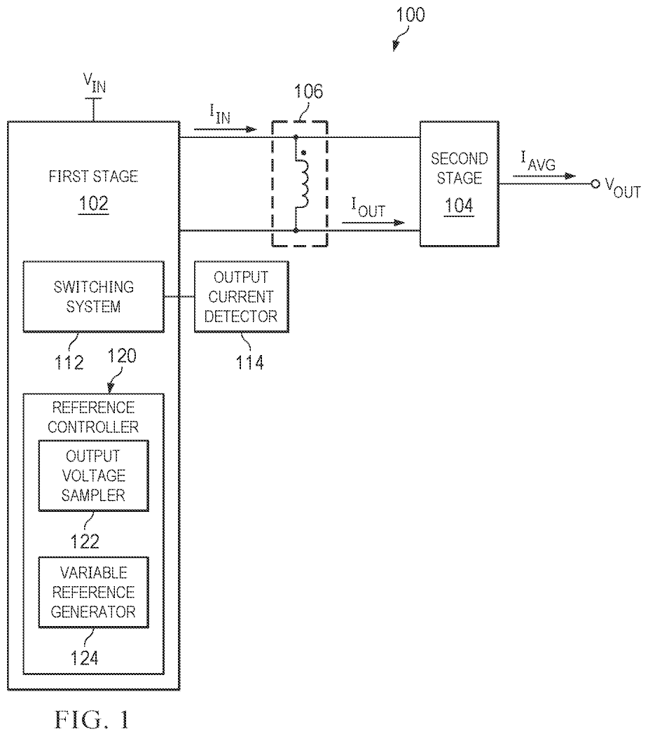

FIG. 1 is a block diagram of an example of a flyback converter system 100. The flyback converter system 100 includes a first stage 102, a second stage 104, and a flyback inductor 106. The first stage 102 includes a switching system 112 and a reference controller 120. The switching system 112 can include one or more switches (e.g., a primary switch) that are activated to provide an input current I_{IN} through the flyback inductor 106. An output current detector 114 can provide an input to the switching system 112 that indicates an instantaneous amplitude of the output current I_{OUT} at the second stage 104. The reference controller 120 includes an output voltage sampler 122 and a variable reference generator 124.

As described herein, the term “activate” with respect to switches (e.g., the primary switch) refers to closing a switch to provide current flow through the switch. Therefore, activating a switch can correspond to providing sufficient bias to a transistor (e.g., V_{GS} voltage) greater than a threshold voltage (e.g., a threshold voltage V_{T}) to operate in linear or saturation mode. Similarly, the term “deactivate” with respect to switches refers to opening a switch to cease current flow through the switch. Therefore, deactivating a switch can correspond to decreasing bias to a transistor less than a threshold voltage to operate in cutoff mode.

In the example of FIG. 1, the switching system 112 is configured to activate a primary switch of the switching system 112 to provide the input current I_{IN} through the flyback inductor 106 in response to an instantaneous amplitude of the output current I_{OUT} at the second stage 104 decreasing below a predetermined threshold (e.g., zero in a transition mode). As used herein, ‘activating’ a switch means providing a sufficient relative bias (e.g., V_{GS}) for a linear mode or a saturation mode to occur. Conversely, ‘deactivating’ the switch means providing approximately zero relative bias (e.g., V_{GS}) to enable a cutoff mode to occur for the switch. The output current detector 114 is configured to detect the instantaneous amplitude of the output current I_{OUT} at the second stage 104. Explained another way, the switching system 112 receives the instantaneous amplitude of the output current I_{OUT} at the second stage 104 as an input from the output current detector 114, and is configured to determine when the input current I_{IN} has reached a peak amplitude I_{PK}.

Additionally, the switching system 112 is configured to deactivate the primary switch of the switching system 112 in response to the input current I_{IN} reaching the peak amplitude I_{PK}. Stated another way, the switching system 112 is configured to deactivate the primary switch of the switching system 112 in response to detecting the input current I_{IN} has an amplitude that exceeds a variable peak current amplitude. In this way, the switching system 112 is configured to control driving of the input current I_{IN} through the flyback inductor 106 to regulate an average amplitude of the output current, demonstrated hereinafter as “I_{AVG}”.

The reference controller 120 is configured to generate the variable peak current amplitude based on an output voltage V_{OUT} at the second stage 104. The output voltage sampler 122 is configured to detect or sample the output voltage V_{OUT} in response to the deactivation of the primary switch or detecting the amplitude of the input current exceeds the variable peak current amplitude. The variable reference generator 124 is configured to facilitate determination of the peak amplitude I_{PK} of the input current I_{IN} based on the amplitude of the output voltage V_{OUT}. For example, the variable reference generator 124 is configured to generate a variable reference voltage corresponding to the variable peak current amplitude based on the output voltage V_{OUT} and a programmable multiplier is associated with a constant average amplitude of the output current I_{AVG}. The second stage 104 is therefore configured to provide the output current I_{AVG} as a constant average output current based on the input current I_{IN} relative to the variable peak current amplitude.

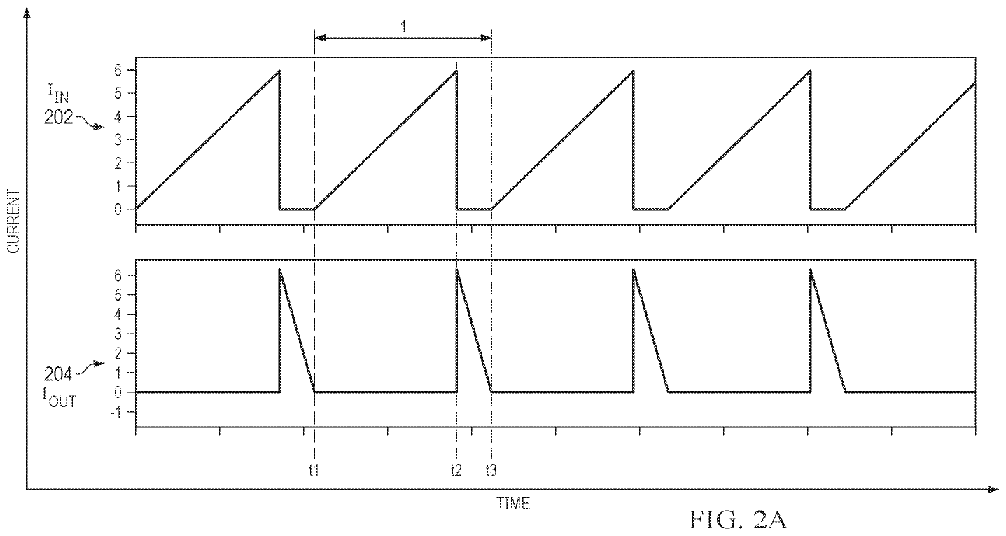

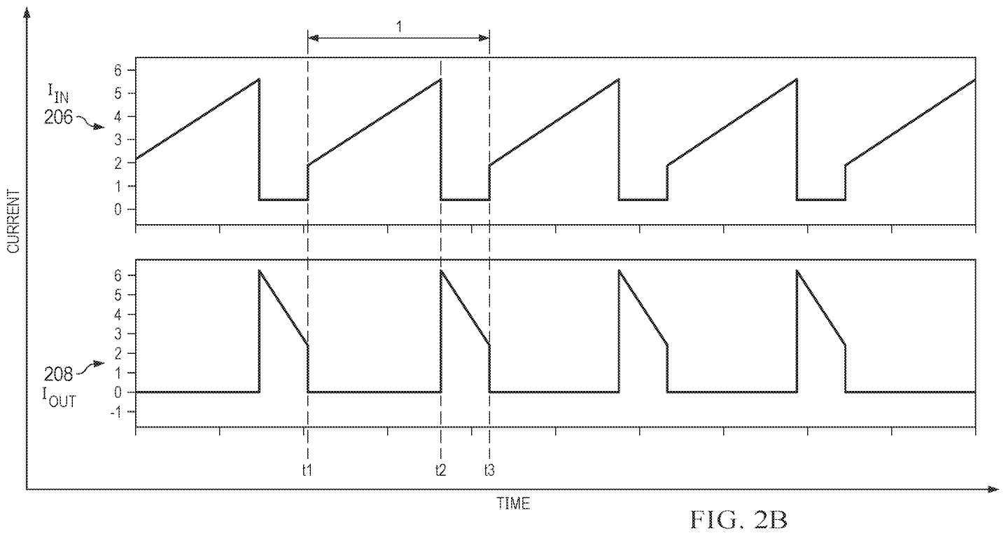

FIG. 2A is a timing diagram of waveforms associated with a flyback converter system, in an example, such as the flyback converter system 100 of FIG. 1. In FIG. 2A, the instantaneous input current I_{IN} through the flyback inductor 106 is represented by waveform 202 and the instantaneous output current I_{OUT} through the flyback inductor 106 is represented by waveform 204.

In an example of an on-off cycle, a duty cycle D (e.g., which corresponds to the on-cycle) for the input current I_{IN} begins at time t1. At time t1, the primary switch of the switching system 112 is activated to provide the input current I_{IN} through the flyback inductor 106. The input current I_{IN} increases linearly to a time t2 based on an amplitude of the input voltage V_{IN}. At time t2, the input current I_{IN} increases greater than the variable peak amplitude I_{PK}. In response, the switching system 112 deactivates the primary switch, resulting in the input current I_{IN} rapidly decreasing to zero amplitude.

In response to deactivation of the primary switch of the switching system 112, the current flows continuously through the flyback inductor 106. Therefore, at time t2, the output current I_{OUT} rapidly increases to generate the output voltage V_{OUT} at the second stage 104. From time t2 to a time t3, the output current I_{OUT} decays based on the output voltage. In the example of FIG. 2A, the output current I_{OUT} decreases to approximately zero at time t3. As an example, in transition mode operation of the flyback converter system 100, the output current I_{OUT} decreases below a predetermined threshold of approximately zero. Therefore, at time t3, the output current detector 114 detects that the output current I_{OUT} has decreased less than the predetermined threshold. In response to detecting that the output current I_{OUT} has decreased less than the predetermined threshold, the output current detector 114 outputs a signal to the switching system 112 to again activate the primary switch of the switching system 112. Accordingly, at time t3, the period of the operation of the flyback converter system 100 concludes. The example of FIG. 2A demonstrates a single period “1” between the time t1 and the time t3. Therefore, at the time t3, a new period begins.

Generally, for converters:

$${P}_{in} = {P}_{out} \qquad ( 1 )$$

### Therefore:

$${I}_{{in}_{avg}} * {V}_{in} = {I}_{{out}_{avg}} * {V}_{out} \qquad ( 2 )$$

In the examples of FIGS. 1-2, the output voltage V_{OUT} is given by:

$${V}_{out} = {V}_{in} \frac{D}{1 - D} \qquad ( 3 )$$

### Solving (3) for D:

$$D = \frac{{V}_{out}}{{V}_{in} + {V}_{out}} \qquad ( 4 )$$

The average output current in transition mode is:

$${I}_{{in}_{avg}} = \frac{{I}_{pk}}{2} D \qquad ( 5 )$$

$${I}_{{out}_{avg}} = \frac{{I}_{pk}}{2} ( 1 - D ) \qquad ( 6 )$$

Substituting Equations (4), (5)->Equation (2) and solving for Iₒᵤₜ_{_{avg}} results in:

$${I}_{{out}_{avg}} = \frac{{I}_{pk} * {V}_{in}}{2 * ( {V}_{in} + {V}_{out} )} \qquad ( 7 )$$

As an example, it may be desirable in some power-conversion applications to have an average output current that is a constant value, represented below by a constant Kᵢ:

$${K}_{i} = \frac{{I}_{pk} * {V}_{in}}{2 * ( {V}_{in} + {V}_{out} )} \qquad ( 8 )$$

The solution of Equation (8) yields the value of the peak current at which to turn off the primary switch in order to regulate the average output current I_{AVG} to the constant value Kᵢ (e.g., independent of both the input voltage V_{IN} and the output voltage V_{OUT}):

$${I}_{pk} = 2 {K}_{i} \frac{( {V}_{in} + {V}_{out} )}{{V}_{in}} = K \frac{( {V}_{in} + {V}_{out} )}{{V}_{in}} \qquad ( 9 )$$

Therefore, generating a reference for the peak amplitude I_{PK} for the input current I_{IN} according to Equation (9) causes the flyback converter system 100 to have a regulated average output current. Stated another way, generating the reference for the peak amplitude I_{PK} for the input current I_{IN} according to Equation (9) causes the flyback converter system 100 to provide the average output current I_{AV}G through the flyback inductor 106 as a constant average output current independent of changes in input voltage V_{IN} or output voltage V_{OUT} for the flyback converter system 100. As demonstrated in Equation (9), the reference controller 120 is configured to generate the variable peak current amplitude based on a sum of the output voltage V_{OUT} and the input voltage V_{IN} divided by the input voltage V_{IN} and multiplied by a programmable multiplier K.

In some applications, it is desirable to control the flyback converter system 100 to provide a constant average output current. For example, if the flyback converter system 100 is being overloaded and the constant average output current is provided, the average output current I_{AVG} will not increase. As another example, for an application such as a battery charger, a battery voltage may be low when a battery is discharged. In this regard, it is desirable to have the output current have a constant average amplitude while the battery is being discharged. Therefore, the first stage 102 includes a circuit configured to regulate or manage the output current I_{AVG} for the flyback converter system 100 such that the average output current I_{AVG} has a constant average output value having a programmable amplitude based on the input voltage V_{IN} and the output voltage V_{OUT}.

As discussed above, the switching system 112 is configured to activate the primary switch of the switching system 112 to provide the input current I_{IN} through the flyback inductor 106 in response to the instantaneous amplitude of the output current I_{OUT} through the flyback inductor 106 falling below the predetermined threshold. The waveform 202 is demonstrated in the example of FIG. 2A as operation of the flyback converter system 100 in a transition mode, such that the threshold for activation of the primary switch(es) is approximately zero.

The example of FIG. 2A demonstrates the currents in a transition mode of operation of the flyback converter system 100. However, the flyback converter system 100 can instead operate in the continuous conduction mode (CCM), such that the threshold for activation of the primary switch(es) is greater than zero, and still provide a constant average current amplitude as described herein, as seen in FIG. 2B. It will be appreciated that when the flyback converter system 100 operates in CCM, one or more of the Equations described herein can be modified accordingly. Additionally, it will be appreciated that the waveforms of FIGS. 2A-2B are not necessarily drawn to scale. For example, Equation (5) can be modified because the threshold for activation of the primary switch(es) is greater than zero in CCM. In either mode, by generating the reference for the peak amplitude I_{PK} for the input current I_{IN} to be proportional to

$$\frac{( {V}_{out} + {V}_{in} )}{{V}_{in}}$$

from Equation (9), the circuit of the first stage 102 can provide a constant average yin output current, regardless of changes in the input voltage V_{IN} or the output voltage V_{OUT}.

In FIG. 2B, for the continuous conduction mode (CCM), the instantaneous input current I_{N} through the flyback inductor 106 is represented by waveform 206 and the instantaneous output current I_{OUT} through the flyback inductor 106 is represented by waveform 208. In an example of an on-off cycle, a duty cycle D (e.g., which corresponds to the on-cycle) for the input current I_{IN} begins at time t1. At time t1, the primary switch of the switching system 112 is activated to provide the input current I_{N} through the flyback inductor 106. The input current I_{IN} increases linearly to a time t2 based on an amplitude of the input voltage V_{IN}. At time t2, the input current I_{IN} increases greater than the variable peak amplitude I_{PK}. In response, the switching system 112 deactivates the primary switch, resulting in the input current I_{IN} rapidly decreasing to zero amplitude.

In response to deactivation of the primary switch of the switching system 112, the current flows continuously through the flyback inductor 106. Therefore, at time t2, the output current I_{OUT} rapidly increases to generate the output voltage V_{OUT} at the second stage 104. From time t2 to a time t3, the output current I_{OUT} decays based on the output voltage V_{OUT}. In the example of FIG. 2B, the output current I_{OUT} decreases to a threshold level at times t1, t3. As an example, in CCM operation of the flyback converter system 100, the output current I_{OUT} decreases below the predetermined threshold to trigger the primary switch of the switching system 112 to provide the input current I_{IN} through the flyback inductor 106. Therefore, at time t3, the output current detector 114 detects that the output current I_{OUT} has decreased less than the predetermined threshold. In response to detecting that the output current I_{OUT} has decreased less than the predetermined threshold, the output current detector 114 outputs a signal to the switching system 112 to again activate the primary switch of the switching system 112. Accordingly, at time t3, the period of the operation of the flyback converter system 100 concludes, and a new period begins.

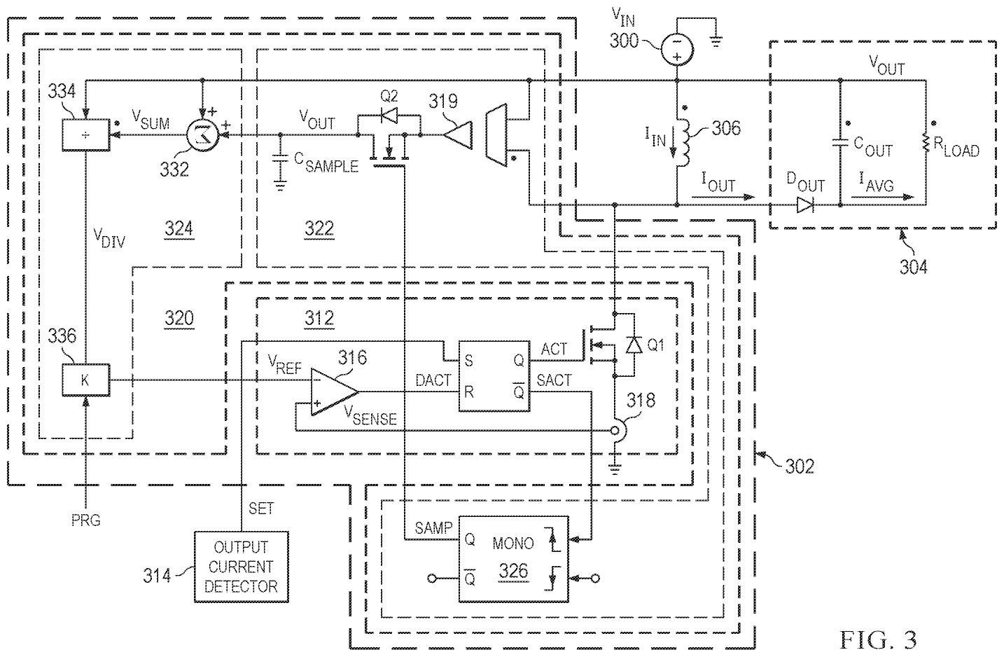

FIG. 3 is a schematic diagram of an example of a current regulation circuit for a flyback converter system 300. The flyback converter system 300 can correspond to the flyback converter system 100 in the example of FIG. 1, and thus demonstrates a more detailed example circuit of the flyback converter 100 in the example of FIG. 1. In FIG. 3, the flyback converter system 300 includes a first stage 302, a second stage 304, and a flyback inductor 306. The flyback inductor 306 has a first terminal and a second terminal. The first stage 302 includes a switching system 312 and a reference controller 320. The reference controller 320 includes an output voltage sampler 322 and a variable reference generator 324.

The switching system 312 includes a primary switch Q1, a set-reset (SR) latch, a comparator 316, and a current sensor 318. The switching system 312 has a first input, a second input, a third input, and an output. The primary switch Q1 has a control terminal, a first terminal, and a second terminal. The SR latch has a first input (e.g., a set input), a second input (e.g., a reset input), a first output (e.g., a non-inverting output), and a second output (e.g., an inverting output). The comparator 316 has a first input, a second input, and an output. The current sensor 318 has an input and an output.

The first input of the switching system 312 is coupled to the second terminal of the flyback inductor 306. The second input of the switching system 312 is coupled to an output of an output current detector 314. The third input of the switching system 312 is coupled to an output of the variable reference generator 324. The output of the switching system 312 is coupled to an input of the output voltage sampler 322.

The set input of the SR latch is coupled to the output of the output current detector 314. The reset input of the SR latch is coupled to an output of the comparator 316. The first, non-inverting output of the SR latch is coupled to the control terminal of the primary switch Q1. The second, inverting output of the SR latch corresponds to the output of the switching system 312 and is coupled to the input of the output voltage sampler 322. The first terminal of the primary switch Q1 is coupled to the second terminal of the flyback inductor 306 and corresponds to the first input of the switching system 312. The second terminal of the primary switch Q1 is coupled to the input of the current sensor 318. The output of the current sensor 318 is coupled to the first input of the comparator 316. The second input of the comparator 316 is coupled to an output of the variable reference generator 324. The reset input of the SR latch is coupled to the output of the comparator 316.

Explained in greater detail, the switching system 312 controls operation of the primary switch Q1 to activate the primary switch Q1 with an activation signal ACT provided in response to the instantaneous amplitude of the output current I_{OUT} falling below the predetermined threshold. For example, the SR latch is coupled to the output current detector 314 and activates the primary switch Q1 in response to the instantaneous amplitude of the output current I_{OUT} falling below the predetermined threshold because the output current detector 314 is configured to provide a set signal SET to the set input of the SR latch in response to detecting when the instantaneous amplitude of the output current I_{OUT} (e.g., current through the second stage 304) has fallen below or is less than a predetermined threshold.

Additionally, the switching system 312 controls operation of the primary switch Q1 to deactivate the primary switch Q1 in response to a deactivation signal DACT from the comparator 316. For example, the comparator 316 generates the deactivation signal DACT in response to a sense voltage V_{SENSE} increasing to greater than a variable reference voltage V_{REF} generated by the variable reference generator 324. The current sensor 318 is configured to generate the sense voltage V_{SENSE}, which is a voltage associated with an amplitude of the input current I_{IN}. The deactivation of the primary switch Q1 can be utilized to trigger the output voltage sampler 322.

The output voltage sampler 322 includes a monostable flip-flop 326, a sampling switch Q2, a voltage sensor 319, and a sampling capacitor C_{SAMPLE}. The output voltage sampler 322 has a first input, a second input, and an output. The voltage sensor 319 has a first terminal, a second terminal, and an output. The monostable flip-flop 326 has a first input, a second input, a first output, and a second output. The first input of the monostable flip-flop 326 corresponds to the second input of the output voltage sampler 322.

The sampling switch Q2 has a control terminal, a first terminal, and a second terminal. The control terminal of the sampling switch Q2 is coupled to the first output of the monostable flip-flop 326. The first terminal of the voltage sensor 319 is coupled to the first terminal of the flyback inductor 306 and an input voltage V_{IN} associated with the flyback inductor 306. The second terminal of the voltage sensor 319 is coupled to the first terminal of the sampling switch Q1 and the second terminal of the flyback inductor 306. The first terminal of the sampling switch Q2 is coupled to the output of the voltage sensor 319. Additionally, the second terminal of the voltage sensor 319 corresponds to the first input of the output voltage sampler 322. The second terminal of the sampling switch Q2 is coupled to the sampling capacitor C_{SAMPLE}. The output of the output voltage sampler 322 is coupled to the sampling capacitor C_{SAMPLE} and provides the output voltage V_{OUT}.

The SR latch is configured to provide a sample activation signal SACT via the inverting output and to activate the output voltage sampler 322 to sample an output voltage V_{OUT} of the flyback inductor 306 in response to the deactivation of the primary switch Q1. In greater detail, the second, inverting output of the SR latch is coupled to the output voltage sampler 322 by way of the first input of the monostable flip-flop 326 and provides the sample activation signal SACT to the monostable flip-flop 326.

As discussed, the deactivation of the primary switch Q1 can be utilized to trigger the output voltage sampler 322. Because the output of the switching system 312 (e.g., the second, inverting output of the SR latch) is synchronous with the deactivation of the primary switch Q1 and coupled with the control terminal of the sampling switch Q2, the monostable flip-flop 326 generates a pulse (e.g., a sampling signal SAMP) to the control terminal in response to the sample activation signal SACT provided from the inverting output of the SR latch upon deactivation of the primary switch Q1, thereby closing the sampling switch Q2 for a predefined duration of time. In this way, the monostable flip-flop 326 is configured to generate the sampling signal SAMP in response to deactivation of the primary switch Q1 and the sampling switch Q2 is configured to be activated in response to the sampling signal SAMP. When the sampling switch Q2 is closed, the sampling capacitor C_{SAMPLE} samples a sampling voltage in response to activation of the sampling switch Q2 because the voltage sensor 319 has a sampling voltage approximately equal to the output voltage V_{OUT}.

The variable reference generator 324 includes a summation component 332, a division component 334, and a multiplication component 336. The variable reference generator 324 has an input and an output. The input of the variable reference generator 324 is coupled to the output of the output voltage sampler 322 (e.g., the sampling capacitor C_{SAMPLE}). The summation component 332 has a first input corresponding to the input of the variable reference generator 324, a second input, and an output. The division component 334 has a first input, a second input, and an output. The multiplication component 336 has an input and an output corresponding to the output of the variable reference generator 324. In this way, the variable reference generator 324 generates the variable reference voltage V_{REF}.

The first input of the summation component 332 is coupled to the sampling capacitor C_{SAMPLE}. The second input of the summation component 332 is coupled to the input voltage V_{IN} associated with the flyback inductor 306. The output of the summation component 332 is coupled to the first input of the division component 334. The second input of the division component 334 is coupled to the input voltage V_{IN}. The output of the division component 334 is coupled to the input of the multiplication component 336. The output of the multiplication component 336 (e.g., the output of the variable reference generator 324) is coupled to the first input of the comparator 316 (e.g., the third input of the switching system 312).

In this way, the summation component 332 is configured to add the sampled output voltage from the sampling capacitor C_{SAMPLE} and the input voltage V_{IN} associated with the input current to generate a summation voltage V_{SUM}. The division component 334 is configured to divide the summation voltage V_{SUM} by the input voltage V_{IN} to generate a division term voltage V_{DIV}. The multiplication component 336 is configured to multiply the division term voltage V_{D}IV by a programmable multiplier associated with a constant average amplitude of the output current to generate a variable voltage reference voltage is associated with the variable peak current amplitude, such that the output current is generated at the constant average amplitude in response to deactivation of the primary switch. Therefore, the variable reference generator 324 operates in accordance with the principles of Equation (9) and can thus provide a constant average output current, as desired, by programming the programmable multiplier accordingly using a programming signal PRG.

The second stage 304 is configured to provide the average output current I_{AVG} as a constant average output current based on the variable peak current amplitude I_{PK}. The second stage 304 includes an output diode D_{OUT}, an output capacitor C_{OUT}, and a load resistor R_{LOAD}. Subsequent to the input current I_{IN} being provided to the flyback inductor 306, in response to the deactivation of the primary switch Q1, the magnetic energy in the flyback inductor 306 is converted into the average output current I_{AVG} that is provided through the second stage 304. Therefore, the average output current I_{AVG} charges the output capacitor C_{OUT} and provides the output voltage V_{OUT} across the load (e.g., represented by the load resistor R_{LOAD} in this example).

In this description, the term “couple” can cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

In this description, a device that is “configured to” perform a task or function can be configured (e.g., programmed and/or hardwired) at a time of manufacturing by a manufacturer to perform the function and/or can be configurable (or reconfigurable) by a user after manufacturing to perform the function and/or other additional or alternative functions. The configuring can be through firmware and/or software programming of the device, through a construction and/or layout of hardware components and interconnections of the device, or a combination thereof. Furthermore, a circuit or device that is described herein as including certain components can instead be configured to couple to those components to form the described circuitry or device. For example, a structure described herein as including one or more semiconductor elements (such as transistors), one or more passive elements (such as resistors, capacitors, and/or inductors), and/or one or more sources (such as voltage and/or current sources) can instead include only the semiconductor elements within a single physical device (e.g., a semiconductor die and/or integrated circuit (IC) package) and can be configured to couple to at least some of the passive elements and/or the sources to form the described structure, either at a time of manufacture or after a time of manufacture, such as by an end-user and/or a third-party.

The phrase “based on” means “based at least in part on”. Therefore, if X is based on Y, X can be a function of Y and any number of other factors.

Modifications are possible in the described embodiments, and other embodiments are possible, within the scope of the claims.

What is claimed is:

1. A circuit, comprising:
a switching system configured to:
activate a primary switch to provide an input current through a flyback inductor in response to an instantaneous amplitude of an output current falling below a predetermined threshold; and
deactivate the primary switch in response to the input current increasing greater than a variable peak current amplitude; and
a reference controller comprising:
an output voltage sampler configured to sample an output voltage of the flyback inductor in response to detecting the input current increasing greater than the variable peak current amplitude; and
a variable reference generator configured to generate the variable peak current amplitude based on the output voltage of the flyback inductor.

2. The circuit of claim 1, wherein the reference controller is configured to generate the variable peak current amplitude also based on a programmable multiplier associated with a constant average amplitude of the output current, such that the output current is generated at the constant average amplitude in response to detecting the input current increasing greater than the variable peak current amplitude.

3. The circuit of claim 2, wherein the reference controller is configured to generate the variable peak current amplitude based on generating a division term voltage that is a sum of the output voltage and an input voltage divided by the input voltage, and by multiplying the division term voltage by the programmable multiplier, the input voltage associated with the input current.

4. The circuit of claim 1, wherein the switching system is configured to receive the instantaneous amplitude of the output current from an output current detector.

5. The circuit of claim 1, wherein the predetermined threshold is zero in a transition mode and greater than zero in a continuous conduction mode (CCM).

6. The circuit of claim 1, wherein the switching system comprises an SR latch having a non-inverting output coupled to the primary switch, an inverting output coupled to the output voltage sampler, a set input coupled to an output current detector to activate the primary switch in response to the instantaneous amplitude of the output current falling below the predetermined threshold, and a reset input to deactivate the primary switch in response to a deactivation signal.

7. The circuit of claim 6, wherein the switching system further comprises:
a current sensor configured to generate a sense voltage associated with an instantaneous amplitude of the input current; and
a comparator configured to provide the deactivation signal in response to the sense voltage increasing to greater than a variable reference voltage generated by the variable reference generator.

8. The circuit of claim 6, wherein the SR latch is configured to provide a sample activation signal via the inverting output to activate the output voltage sampler configured to sample an output voltage of the flyback inductor in response to detecting the input current increasing greater than the variable peak current amplitude.

9. The circuit of claim 1, wherein the output voltage sampler comprises:
a voltage sensor having a sampling voltage approximately equal to the output voltage;
a sampling switch coupled to the voltage sensor, the sampling switch being activated in response to a sampling signal;
a sampling capacitor coupled to the sampling switch, the sampling capacitor being configured to sample the sampling voltage in response to activation of the sampling switch; and
a monostable flip-flop configured to generate the sampling signal in response to detecting the input current increasing greater than the variable peak current amplitude.

10. The circuit of claim 1, wherein the variable reference generator comprises:
a summation component configured to add the sampled output voltage and an input voltage associated with the input current to generate a summation voltage;
a division component configured to divide the summation voltage by the input voltage to generate a division term voltage; and
a multiplication component configured to multiply the division term voltage by a programmable multiplier associated with a constant average amplitude of the output current to generate a variable voltage reference voltage associated with the variable peak current amplitude.

11. A flyback converter system, comprising:
a first stage comprising:
a switching system configured to:
activate a primary switch to provide an input current through a flyback inductor in response to an instantaneous amplitude of an output current falling below a predetermined threshold; and
deactivate the primary switch in response to the input current increasing greater than a variable peak current amplitude;
a reference controller configured to:
sample an output voltage at the flyback inductor in response to deactivation of the primary switch; and
generate the variable peak current amplitude based on the output voltage of the flyback inductor; and
a second stage configured to provide the output current as a constant average output current based on the variable peak current amplitude.

12. The flyback converter system of claim 11, wherein the switching system comprises an SR latch having a non-inverting output coupled to the primary switch, an inverting output coupled to an output voltage sampler, a set input coupled to an output current detector to activate the primary switch in response to the instantaneous amplitude of the output current falling below the predetermined threshold, and a reset input to deactivate the primary switch in response to a deactivation signal.

13. The flyback converter system of claim 12, wherein the switching system further comprises:
a current sensor configured to generate a sense voltage associated with an instantaneous amplitude of the input current; and
a comparator configured to provide the deactivation signal in response to the sense voltage increasing to greater than a variable reference voltage generated by the reference controller.

14. The flyback converter system of claim 12, wherein the output voltage sampler comprises:
a voltage sensor having a sampling voltage approximately equal to the output voltage;
a sampling switch coupled to the voltage sensor, the sampling switch being activated in response to a sampling signal;
a sampling capacitor coupled to the sampling switch, the sampling capacitor being configured to sample the sampling voltage in response to activation of the sampling switch; and
a monostable flip-flop configured to generate the sampling signal in response to deactivation of the primary switch.

15. The flyback converter system of claim 11, wherein the reference controller includes a variable reference generator comprising:
a summation component configured to add the sampled output voltage and an input voltage associated with the input current to generate a summation voltage;
a division component configured to divide the summation voltage by the input voltage to generate a division term voltage; and
a multiplication component configured to multiply the division term voltage by a programmable multiplier associated with a constant average amplitude of the output current to generate a variable voltage reference voltage associated with the variable peak current amplitude.

16. The flyback converter system of claim 11, wherein the reference controller is configured to generate the variable peak current amplitude based on generating a division term voltage that is a sum of the output voltage and an input voltage divided by the input voltage, and by multiplying the division term voltage by a programmable multiplier associated with a constant average amplitude of the output current, such that the output current is generated at the constant average amplitude in response to deactivation of the primary switch.

17. A circuit, comprising:
a switching system having a first input, a second input, a third input, and an output, the first input of the switching system being coupled to a flyback inductor, the second input of the switching system being coupled to an output of an output current detector; and
a reference controller, comprising:
an output voltage sampler having a first input, a second input, and an output, the first input of the output voltage sampler being coupled to the flyback inductor, the second input of the output voltage sampler being coupled to the output of the switching system; and
a variable reference generator having an input and an output, the input of the variable reference generator being coupled to the output of the output voltage sampler, and the output of the variable reference generator being coupled to the third input of the switching system.

18. The circuit of claim 17, wherein the switching system comprises:
a primary switch having a control terminal, a first terminal, and a second terminal, wherein the first terminal is the first input of the switching system;
a current sensor having an input and an output, the input of the current sensor being coupled to the second terminal of the primary switch;
a comparator having a first input, a second input, and an output, the first input of the comparator being coupled to the output of the current sensor, the second input of the comparator being coupled to the output of the variable reference generator; and
an SR latch having a first input, a second input, a first output, and a second output, the first input of the SR latch corresponding to the second input of the switching system, the second input of the SR latch being coupled to the output of the comparator, the first output of the SR latch being coupled to the control terminal of the primary switch, and the second output corresponding to the output of the switching system.

19. The circuit of claim 17, wherein the output voltage sampler comprises:
a voltage sensor having a sampling voltage approximately equal to an output voltage of the flyback inductor;
a sampling switch coupled to the voltage sensor, the sampling switch being activated in response to a sampling signal;
a sampling capacitor coupled to the sampling switch, the sampling capacitor being configured to sample the sampling voltage in response to activation of the sampling switch; and
a monostable flip-flop configured to generate the sampling signal in response to deactivation of a primary switch of the switching system.

20. The circuit of claim 19, wherein the variable reference generator comprises:
a summation component configured to add the sampled output voltage and an input voltage associated with an input current of a flyback inductor to generate a summation voltage;
a division component configured to divide the summation voltage by the input voltage to generate a division term voltage; and
a multiplication component configured to multiply the division term voltage by a programmable multiplier associated with a constant average amplitude of output current of the flyback inductor to generate a variable voltage reference voltage associated with a variable peak current amplitude.
